(19) United States
(12) Patent Application Publication
(10) Pub. No.: US 2022/0058318 A1
(43) Pub. Date: Feb. 24, 2022

(54) SYSTEM FOR PERFORMING AN XIL-BASED SIMULATION

(71) Applicant: FORD GLOBAL TECHNOLOGIES, LLC, Dearborn, MI (US)

(72) Inventors: Turgay Isik ASLANDERE, Aachen (DE); Cem MENGI, Aachen (DE)

(73) Assignee: FORD GLOBAL TECHNOLOGIES, LLC, Dearborn, MI (US)

(21) Appl. No.: 17/389,678

(22) Filed: Jul. 30, 2021

(30) Foreign Application Priority Data
Aug. 20, 2020 (DE) 102020210600.2

(51) Int. Cl. G06F 30/27; G07C 5/08; G06N 3/08

(52) U.S. Cl. CPC G06F 30/27; G06N 3/08; G07C 5/085

(57) ABSTRACT

Systems and method for performing an XiL-based simulation are provided. Operating data sets (BDS) are read, An artificial intelligence system is trained with the operating data sets (BDS) Test data sets (TDS) are generated using the trained artificial intelligence system. The test data sets (TDS) are provided for the XiL simulation.

### CROSS-REFERENCE TO RELATED APPLICATIONS

This application claims foreign priority benefits under 35 U.S.C. § 119(a)-(d) to DE Application 10 2020 210 600.2 filed Aug. 20, 2020, which is hereby incorporated by reference in its entirety.

### TECHNICAL FIELD

The invention relates to a system for performing an XiL-based simulation.

### BACKGROUND

XiL based simulations can be simulations based on model-in-the-loop (MiL), software-in-the-loop (SiL), processor-in-the-loop (PiL), and/or hardware-in-the-loop (HiL). MiL comprises the construction of models for a control system and an ECU for behavioral simulation. SiL is the creation of models in the target language of the ECU for the automated testing of software developments, PiL is the testing of processors, and HiL refers to a method in which an embedded system (e.g. a real electronic ECU or real mechatronic components, i.e. hardware) is connected to a matched counterpart via its inputs and outputs.

Such XiL-based simulations support development projects, e.g. in the field of rapid prototyping. A well-known XiL system is dSpace XiL simulations.

In the context of such XiL-based simulations, XiL components are subjected to test data sets that have been temporarily stored in a cloud, with the test data sets originating from motor vehicles of a vehicle fleet, a satellite system, and/or a V2X system. Such methods are known from CN 110687828 A or U.S. Pat. No. 10,169,928 B2, for example. A method for rapid prototyping is known from CN 110837231 A.

However, it is currently not possible to use operating data sets from a cloud.

There is therefore a need to identify ways in which such XiL-based simulations can be further improved.

### SUMMARY

The object of the invention is achieved by a method for performing an XiL-based simulation, having the steps of reading in operating data sets, training an artificial intelligence system with the operating data sets, generating test data sets with the trained artificial intelligence system, and providing the test data sets for the XiL simulation.

The operating data sets contain data that is generated, for example, during the operation of motor vehicles. It can be vehicle-internal data, such as data that is transmitted, for example, by means of a CAN bus of a motor vehicle. However, it can also be traffic-specific data that is representative, for example, of traffic volumes or current traffic situations.

The artificial intelligence system is designed for machine learning. Machine learning means the generation of knowledge from experience, i.e. an artificial intelligence system learns from examples and can generalize from these after completion of a training phase. Machine learning uses algorithms to generate a statistical model based on training data. In other words, the examples are not merely learned by rote, rather patterns and regularities in the training data are detected. In this way, the artificial intelligence system can also evaluate unseen data (learning transfer). During the training phase, the artificial intelligence system can be trained by means of supervised or unsupervised learning.

The test data sets can contain, for example, traffic data, maintenance data, mapping data for the environment in specific GPS coordinates, drive-train related data (e.g. energy recovery information for EBV [electronic brake-force distribution] and hybrid vehicles, as well as regeneration processes for internal combustion engines for specific components), the approximate status of vehicle components, and all types of data not contained in the existing operating data sets.

According to one embodiment the artificial intelligence system classifies the operating data sets in order to obtain classified operating data sets. The classification process allocates the operating data sets to different classes. Accordingly, during a training phase of the artificial intelligence system preceding the actual operation, the system is trained to a corresponding classification. In other words, the operating data sets are pre-sorted. Thus, the test data sets based on suitable operating data sets for the XiL simulation to be executed are available for the respective XiL simulations.

According to a further embodiment, the artificial intelligence system extends the test data sets to include extended test data sets. In this way, gaps in the test data sets can be filled and closed. Thus, the basis of the test data is broadened. Accordingly, during a training phase of the artificial intelligence system preceding the actual operation, the system is trained to a corresponding extension.

According to a further embodiment a multilayer neural network, a recurrent neural network, a convolutional neural network, or an autoencoder is used as the artificial intelligence system. Such artificial neural nets, also known as artificial neural networks, in short: ANN, are networks of artificial neurons. These neurons (also nodes) of an artificial neural network are arranged in layers and are usually connected to each other in a fixed hierarchy. The neurons are usually connected between two layers, but in rare cases also within one layer. A multilayer or deep neural network means an artificial neural network with an input layer, a plurality of intermediate layers, and an output layer. The multilayer neural network can be a recurrent neural network (RNN). Recurrent neural networks are artificial neural networks which, in contrast to feedforward neural networks, are characterized by connections of neurons of one layer to neurons of the same or a preceding layer. A convolutional neural network (CNN) is an artificial neural network for classification with one or more convolutional layers and a pooling layer. These kinds of artificial neural networks are exposed to training data sets during a training phase prior to their initial operation. For example, by means of the method of error back-propagation, the artificial neural network is trained by modifying the weight factors of the artificial neurons of the neural network in order to achieve the most reliable mapping of given input vectors to given output vectors. In addition, the artificial neural network, in particular the multilayer neural network, can have a long short-term memory (LSTM) to improve the training results. Training can be carried out by means of supervised, unsupervised or reinforcement learning. An autoencoder is another type of artificial neural network which is used to learn efficient coding patterns. The goal of an autoencoder is to learn a compressed representation (encoding) for a set of data and thereby extract essential features. This allows it to be used for dimensional reduction. The use of a trained artificial neural network allows a user to take advantage of its ability to learn, its parallelism, fault tolerance, and robustness against errors.

According to one embodiment, operating data sets derived from motor vehicles of a fleet of vehicles and/or a satellite system and/or a V2X system are used. Motor vehicles in a vehicle fleet are understood to mean a multiplicity of motor vehicles of the same design or that are at least technically related to each other. The operating data is then transmitted wirelessly, e.g. according to the 5G standard, to a cloud computer with the artificial intelligence system. The satellite system can be a network of a multiplicity of satellites, such as those of a satellite-based navigation system such as GPS or GALILEO. V2X systems (vehicle-to-everything) can be vehicle-to-vehicle (V2V), vehicle-to-road (V2R), vehicle-to-infrastructure (V2I), vehicle-to-network (V2N), and vehicle-to-persons (V2P) communications.

Furthermore, the invention also includes a computer program product for implementing such a method and such a system.

### BRIEF DESCRIPTION OF THE DRAWINGS

The invention will now be explained with reference to a drawing. In the drawings:

FIG. 1 shows a schematic representation of a system for performing an XiL-based simulation.

FIG. 2 shows a schematic representation of further details of the system shown in FIG.

FIG. 3 shows a schematic representation of a method sequence for training the artificial intelligence system.

FIG. 4 shows a schematic representation of a method sequence for operating the system shown in FIG. 1.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

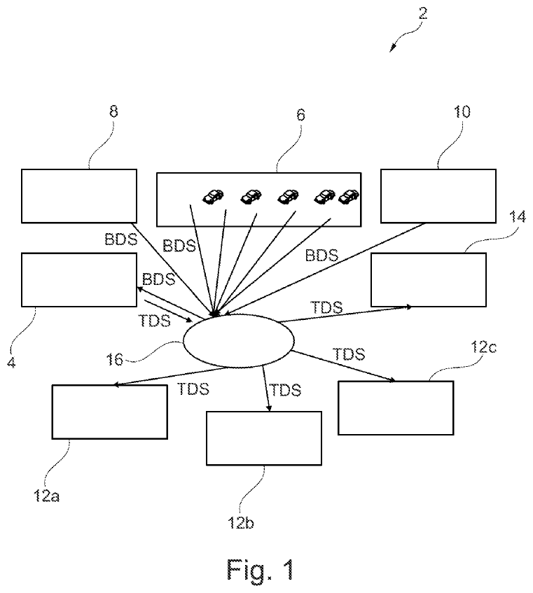

Reference is made to FIG. 1 first. The system 2 is designed to perform an XiL-based simulation. The XiL-based simulation can be simulations based on model-in-the-loop (MiL), software-in-the-loop (SiL), processor-in-the-loop (PiL), and/or hardware-in-the-loop (HiL).

It should be noted that the system 2 can also be designed to perform a multiplicity of XiL-based simulations, which are carried out in series or parallel, or simultaneously.

As part of such XiL-based simulations, XiL components 12a, 12b, 12c and a simulation node 14 are exposed to test data sets IDS which have been temporarily stored in a cloud 16. The cloud 16 in the present exemplary embodiment is a computer network. By contrast, it can also be a computer with a different architecture.

The cloud 16 is designed to read in operating data sets, which in the present exemplary embodiment originate from motor vehicles of a vehicle fleet 6, a satellite system 8, and/or a V2X system 10, by means of a wireless data transmission link, e.g. complying with the 5G standard.

Motor vehicles of a vehicle fleet 6 are understood to mean a multiplicity of motor vehicles of the same design, or that are at least technically related to each other. The satellite system 8 can be a network of a multiplicity of satellites, such as those of a satellite-based navigation system. The V2X system 10 (vehicle-to-everything) can be designed for vehicle-to-vehicle (V2V), vehicle-to-road (V2R) and/or vehicle-to-infrastructure (V2I) and/or vehicle-to-network (V2N) and/or vehicle-to-persons (V2I) communications.

The operating data sets (BDS) contain data that is generated during the operation of the motor vehicles of the vehicle fleet 6. It can be vehicle-internal data, such as data that is transmitted by means of a CAN bus or other vehicle-internal bus system of the motor vehicles in the vehicle fleet 6. However, it can also be traffic-specific data that is representative, for example, of traffic volumes or current traffic situations. It goes without saying that the motor vehicles of a vehicle fleet 6 and/or the satellite system 8 and/or the V2X system 10 have transmission devices for the wireless transmission of the operating data sets RDS to the cloud 16. For these tasks and/or functions and those described below, the system 2 and its components as well as the motor vehicles of a vehicle fleet 6 and/or the satellite system 8 and/or the V2X system 10 can have appropriately designed hardware and/or software components.

Furthermore, the system 2 is assigned an artificial intelligence system 4 which is designed to evaluate the operating data sets RIDS to provide test data sets (TDS). The artificial intelligence system 4 may also have hardware and/or software components for the tasks and/or functions described below.

Such an artificial intelligence system 4 is designed for machine learning. Machine learning means the generation of knowledge from experience, i.e. the artificial intelligence system 4 learns from examples and can generalize from these after completion of a training phase. Machine learning uses algorithms to generate a statistical model based on training data. In other words, the examples are not merely learned by rote, rather patterns and regularities in the training data are detected. In this way, the artificial intelligence system can also evaluate unseen data (learning transfer). During the training phase, the artificial intelligence system can be trained by means of supervised or unsupervised learning.

A multilayer neural network, a recurrent neural network, a convolutional neural network, or an autoencoder can be used for the artificial intelligence system 4. Such artificial neural nets, also known as artificial neural networks (ANN), are networks of artificial neurons. These neurons (also nodes) of an artificial neural network are arranged in layers and are usually connected to each other in a fixed hierarchy. The neurons are usually connected between two layers, but in rare cases also within one layer. A multilayer or deep neural network means an artificial neural network with an input layer, a plurality of intermediate layers, and an output layer. The multilayer neural network can be a recurrent neural network (RNN). Recurrent neural networks are artificial neural networks which, in contrast to feedforward neural networks, are characterized by connections of neurons of one layer to neurons of the same or a preceding layer. A convolutional neural network (CNN) is an artificial neural network for classification with one or more convolutional layers and a pooling layer. These kinds of artificial neural networks are exposed to training data sets during a training phase prior to their initial operation. For example, by means of the method of error back-propagation, the artificial neural network is trained by modifying the weight factors of the artificial neurons of the neural network in order to achieve the most reliable mapping of given input vectors to given output vectors. In addition, the artificial neural network, in particular the multilayer neural network, can have a long short-term memory (LSTM) to improve the training results. Training can be carried out by means of supervised, unsupervised or reinforcement learning. An autoencoder is another type of artificial neural network which is used to learn efficient coding patterns. The goal of an autoencoder is to learn a compressed representation (encoding) for a set of data and thereby extract essential features. This allows it to be used for dimensional reduction. The use of a trained artificial neural network allows a user to take advantage of its ability to learn, its parallelism, fault tolerance, and robustness against errors.

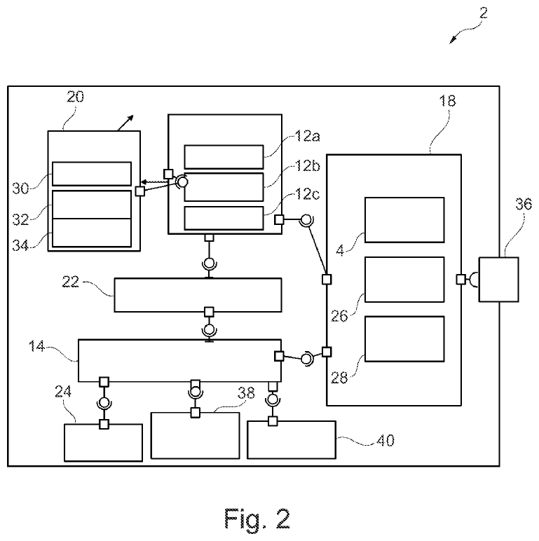

The system 2 and its components will now be explained in more detail with additional reference to FIG. 2.

The system 2 and its components in the present exemplary embodiment are designed for both uni- and/or bi-directional data exchange and therefore have corresponding interfaces, such as USB standard connections (USB2, USB3, USB3.1 Thunderbolt), Ethernet (UDP, TCP/IP, P2P connection protocols), LIN, CAN, and joint use of a shared hard disk via shared storage protocols. Furthermore, the system 2 has a system interface 36.

The following components of the system 2 are shown: a computer unit 18, the XiL components 12a, 12b, 12c, an actuator and diagnostic device module 20, a synchronization module 22, the simulation node 14 and an HMI 24, an interface 38 and a further simulation node 40. Both the simulation node 14 and the further simulation node 40 can be designed as a hub.

The computer unit 18 for cloud access is a computer unit that retrieves cloud data from cloud databases (e.g. Ford Vehicle Analytics databases, Google Maps, satellite image databases, connected vehicles/modems) and archives it in its memory 26. It can be a high-performance computer consisting of multiple racks of computer units, a portable mobile desktop with external eGPUs, or a desktop computer with high computing power. In order to exchange data with hardware elements specifically for HiL components, the computer unit 18 can also have communication hardware 28.

This allows various connections to be made such as USB to CAN, LIN or Ethernet to CAN or LIN. It can be equipped with real-time CPUs for processing data and to send it to the XiL components 12a, 12b, 12c and/or the simulation node 14 simultaneously.

In the event that there is no direct connection to cloud services or to the internet, the memory 26 can be used to provide data for the XiL components 12a, 12b, 12c in an offline mode. This can be offline vehicle-CAN data recording data, for example.

In the present exemplary embodiment, the artificial intelligence system 4 is implemented as part of the computer unit 18.

The artificial intelligence system 4 can be designed as a connected device or an embedded computing AI unit that has AI processing units, such as Tensor Processing Units/GPUs. It can be designed as a USB stick.

The test data sets TDS can contain, for example, traffic data, maintenance data, mapping data for the environment in specific GPS coordinates, drive-train related data (e.g. energy recovery information for EBV [electronic brake-force distribution] and hybrid vehicles, as well as regeneration processes for internal combustion engines for specific components:), the approximate status of vehicle components, and all types of data not contained in the existing operating data sets BDS. Therefore, additional data is created by means of prediction using the existing operating data. sets BDS in order to determine supplementary data sets, which are then merged with existing test data sets TDS in order to generate extended test data sets TDS.

The XiL, components 12a, 12b, 12c can comprise, for example, flashed/programmed hardware elements such as electronic control units (ECUs) as well as a software model of the hardware elements. These can be real vehicle components, such as HMI units, sensors, control units and software models of these, which are installed in a computer unit with the required input/output interfaces. They can be connected to actuators that can also be located in a motor vehicle during the driving cycle, in a test stand 28 or as a single actuator unit in the motor vehicle. In addition, diagnostic devices may be provided. The XiL components 12a, 12b, 12c can also be connected to the simulation node 14 for data exchange so that a simulation result of one of the XiL components 12a, 12b, 12c can be displayed and/or be the object of another simulation. This allows more input data to be provided for other XiL components 12a, 12b, 12c. In addition, the XiL components 12a, 12b, 12c can receive data from the simulation node 14. For example, an XiL component 12a, 12b, 12c is an engine control unit which requires different types of input data, such as engine speed, temperature and pressure-related data. These data can be provided by the simulation node 14 in which the drive train of a motor vehicle is simulated.

The test data sets TDS are also used by the XiL components 12a, 12b, 12c. For example, there may be a need to simulate a driving assistance function. GPS coordinates and all vehicle component-related data are archived in the cloud 16. The system to be tested can then be simulated using data with the simulation environment provided by the simulation node 14.

The actuator and diagnostic device module 20 can also be located in a motor vehicle of the vehicle fleet 6 or in a test stand 30 or a single actuator 32 during a driving cycle. A diagnostic device can be connected to any one of the XiL components 12a, 12b, 12c. An actuator can translate a simulation into reality. If, for example, a motor vehicle component, such as an engine at the simulation node 14, is started in a VR environment by an HMI 24, the engine in the test stand 28 can be started by the actuator 32. Thus, the corresponding engine data from the XiL components 12a, 12b, 12c can be used for further simulations and/or tests.

Since the simulation node 14 may not run in real time due to latency times of the simulation loads, it is expected that the XiL components 12a, 12b, 12c will run in real time. In addition, the visual simulations require a predefined minimum update rate, while the XiL components 12a, 12b, 12c require a maximum delay of 2 to 5 ms. The synchronization module 22 is therefore provided, which is designed to avoid delays between the simulation and the XiL components 12a, 12b, 12c.

If multiple simulation nodes 14 are provided, it also synchronizes the runtime of the simulation nodes 14 and the XiL, components 12a, 12b, 12c overall.

The simulation node 14 comprises simulation-related components. The simulation can run on a desktop computer, a supercomputer, laptops, or portable computer units. It consists primarily of a software tool for simulating these results and a software tool for visualizing the simulation results.

If it receives all simulation data from the XiL components 12a, 12b, 12c, it comprises a software tool for the simulation.

The simulation node 14 consists of a virtual environment, a real-time rendering engine that uses a rasterization (depth buffer) based rendering approach, such as OpenGL or DirectX with a physics engine such as Open Source Bullet Engine or Nvidia PhysX Engine. This can be a game engine such as Unity3D, Unreal, or CryEngine.

A virtual environment is a virtual reality, or VR for short, that is, a graphical display of a simulated reality and its physical properties in real time. In other words, it is a computer-generated, interactive virtual environment,

It can also act as an interface to driving simulators. In that case it uses the visual and physical modules of a driving simulator as well as their connection to other hardware elements. In this case, the use of visualization and simulation software is not required.

It reads the test data sets TDS and assigns them directly to the simulations and the visualizations. For example, real-time traffic data and/or a digital map of a destination area with the data of a motor vehicle can be used to test vehicle components in simulated real-world driving scenarios. The destination area can also be displayed in real time using a street map and traffic information from the cloud 16. Visual display allows engineers to track a test in VR, AR, and ML environments.

The simulation node 14 can also allow the repetition or reproduction of recorded simulation scenarios and the modification of simulation scenarios for early prototyping.

The simulation node 14 also has an interface for at least one HMI 24. It can be a tracking unit, such as Leap Motion for finger tracking, HTC Vive for HMD tracking, Intel Real Sense for people tracking and network creation, or ART-Track for precise tracking of tracking targets. The HMI 24 can be a remote control, HTC Vive, Oculus Rift Controller and/or also be designed for haptic feedback. The RMI 24 can also be configured as a projector, monitor, CAVEs, augmented display, head mounted displays (HMD), transparent displays or heads up units. This interface enables virtual-reality, augmented-reality and mixed-reality applications. For example, users can use this function to control the behavior of the XiL components 12a, 12b, 12c, for example, via a 3D interface, and the users can gain insight into the functions of the XiL components 12a, 12b, 12c through immersion.

The simulation node 14 can also comprise the additional interface 38 to simulation tools such as IPG Carmaker, CarSim, and Matlab Simulink Simulation Tools. It can use just a graphical display of the tools, e.g, animations/drawings, or else the physics of these simulation tools (e.g. Simulink Tool Boxes), or else entire simulation tool chains are used to expand its capabilities, such as connecting to the XiL components 12a, 12b, 12c or activating VR, AR and MR capacities.

In order to enable a remote connection and virtual collaborative engineering work, an interface is provided for a connection to at least the additional simulation node 40. This allows prototypes to be created and then tested in multiple virtual simulation environments that are controlled by multiple users. The simulation nodes 14 can all be structured in a similar way.

An AI agent can replace a component of the simulation node 14. The AT agent can comprise artificial neural networks. The AI agent can act as a true simulation node because it is designed based on data from a simulation center. In this case, the AI agent can be used for physical data only, for visual data only, or for both.

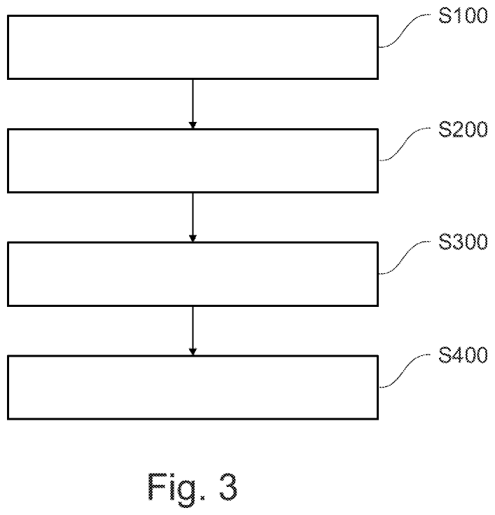

Reference will now additionally be made to FIG. 3 in order to explain the training and operation of the artificial intelligence system 4.

During a training phase performed prior to the actual operation, the artificial intelligence system 4 uses the operating data sets BDS read from the cloud 16 in a first step S100 in order to train supervised-learning AI units, such as multilayer neural networks (DNN—deep neural networks), recurrent neural networks (RNN), and convolutional neural networks (CNN), in a further step S200. During the training phase, older machine learning methods, such as decision trees, e.g. random forests, can also be used. Even unsupervised-learning AI units, such as autoencoders or reinforcement learning, can be used not only to create test data sets TDS but also to supplement existing test data sets TDS in order to generate extended test data sets TDS.

After the training, the test data sets TDS can be generated with the trained artificial intelligence system 4 and, in a further step S400, can be fed into both the XiL components 12a, 12b, 12c and the simulation node 14.

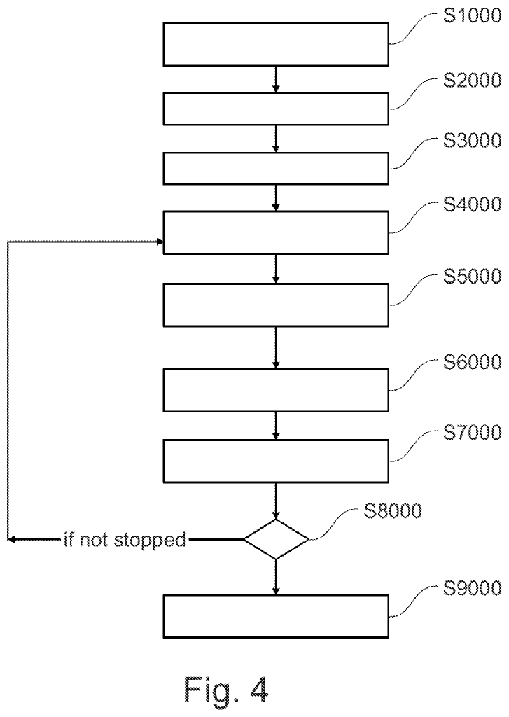

A method sequence for operating the system 2 will now be explained with additional reference to FIG. 4.

In a first step S1000, one of the XiL, components 12a, 12b, 12c is started.

In a further step S2000, the computer unit 18 is started.

In a further step S3000, the connections for data exchange are set up.

In a further step S4000, the test data sets TDS are transferred to the respective XiL components 12a, 12b, 12c and the simulation node 14.

In a further step S5000, data is exchanged bi-directionally between the XiL components 12a, 12b, 12c, the simulation node 14, the diagnostic device module 20, the interface 38 and the additional simulation node 40.

In a further step S6000, data is exchanged bi-directionally between the HMI 24 and the simulation node 14.

In a further step S7000, the data is displayed to a user using the HMI 24.

If the method is not terminated in step S8000, the method is continued with the further step S4000. Otherwise, the method ends with a further step S9000.

In deviation from the present exemplary embodiment, the order of the steps can also be different. In addition, a plurality of steps can also be executed at once or simultaneously. Furthermore, in another deviation from the present exemplary embodiment, individual steps can be skipped or omitted.

This ensures that the appropriate test data sets TDS are available to the respective components 12a, 12b, 12c.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. A method for performing an XiL-based simulation of XiL components, comprising:
reading in operating data sets (BDS) containing data generated during operation of motor vehicles of a vehicle fleet;
training an artificial intelligence system with the operating data sets (BDS) to identify patterns in the operating data sets (BDS);
generating test data sets (TDS) with the trained artificial intelligence system consistent with the operating data sets (BDS); and
providing the test data sets (TDS) for the XiL simulation.

2. The method according to claim 1, wherein the artificial intelligence system classifies the operating data sets (BDS) to obtain classified operating data sets.

3. The method according to claim 1, further comprising:
creating supplementary data sets by prediction using the artificial intelligence system and the operating data sets (BDS), the supplementary data including additional data elements not included in the operating data sets that are required for performing the XiL simulation; and
merging the supplementary data sets with the test data sets to generate extended test data sets TDS for the XiL simulation.

4. The method according to claim 1, wherein a multilayer neural network, a recurrent neural network, a convolutional neural network, or an autoencoder is used as the artificial intelligence system.

5. The method according to claim 1, wherein the operating data sets (BDS) used are derived from the motor vehicles of the vehicle fleet and/or a satellite system and/or a V2X system.

6. The method according to claim 1, wherein the operating data sets (BDS) include vehicle bus data and traffic-specific data representative of traffic volumes or current traffic situations, and the test data sets (TDS) include traffic data, maintenance data, mapping data for the environment in specific GPS coordinates, drive-train related data, and status of vehicle components.

7. The method according to claim 1, wherein the XiL components include hardware vehicle components and a software model of the hardware vehicle components, and the XiL components configured to receive the test data sets (TDS) for performing the XiL simulation.

8. The method according to claim 1, further comprising:
determining simulation results of the XiL simulation; and
visualizing the simulation results.

9. A non-transitory computer-readable medium comprising instructions for perfuming an XiL-based simulation of XiL components, that, when executed by one or more computer units, cause the one or more computer units to perform operations including to:
read in operating data sets (BDS) containing data generated during operation of motor vehicles of a vehicle fleet;
train an artificial intelligence system with the operating data sets (BDS) to identify patterns in the operating data sets (BDS);
generate test data sets (TDS) with the trained artificial intelligence system consistent with the operating data sets (BDS); and
provide the test data sets (TDS) for the XiL simulation.

10. The medium according to claim 9, further comprising instructions, that, when executed by the one or more computer units, cause the one or more computer units to perform operations including to classify the operating data sets (BDS) to obtain classified operating data sets.

11. The medium according to claim 9, further comprising instructions, that, when executed by the one or more computer units, cause the one or more computer units to perform operations including to:
create supplementary data sets by prediction using the artificial intelligence system and the operating data sets (BDS), the supplementary data including additional data elements not included in the operating data sets that are required for performing the XiL simulation; and
merge the supplementary data sets with the test data sets to generate extended test data sets TDS for the XII, simulation.

12. The medium according to claim 9, further comprising instructions, that, when executed by the one or more computer units, cause the one or more computer units to perform operations including to utilize one or more of a multilayer neural network, a recurrent neural network, a convolutional neural network, or an autoencoder as the artificial intelligence system.

13. The medium according to claim 9, further comprising instructions, that, when executed by the one or more computer units, cause the one or more computer units to perform operations including to derive the operating data sets (BDS) from the motor vehicles of the vehicle fleet and/or a satellite system and/or a V2X system.

14. The medium according to claim 9, wherein the operating data sets (BDS) include vehicle bus data and traffic-specific data representative of traffic volumes or current traffic situations, and the test data sets (TDS) include traffic data, maintenance data, mapping data for the environment in specific GPS coordinates, drive-train related data, and status of vehicle components.

15. The medium according to claim 9, wherein the XiL, components include hardware vehicle components and a software model of the hardware vehicle components, and the XiL, components configured to receive the test data sets (TDS) for performing the XiL simulation, and, further comprising instructions, that, when executed by the one or more computer units, cause the one or more computer units to perform operations including to:
determine simulation results of the simulation using the XiL components; and
visualize the simulation results of the XiL components.

16. A system for performing an XiL-based simulation of of XiL components, comprising: one or more computer units configured to perform operations including to
read in operating data sets (BBS) containing data generated during operation of motor vehicles of a vehicle fleet;
train an artificial intelligence system with the operating data sets (BDS) to identify patterns in the operating data sets (BDS);
generate test data sets (TDS) with the trained artificial intelligence system consistent with the operating data sets (BDS); and
provide the test data sets (TDS) for the XiL simulation.

17. The system according to claim 16, wherein the one or more computer units are further configured to perform operations including to:
create supplementary data sets by prediction using the artificial intelligence system and the operating data sets (BDS), the supplementary data including additional data elements not included in the operating data sets that are required for performing the XiL simulation; and
merge the supplementary data sets with the test data sets to generate extended test data sets TDS for the XiL simulation.

18. The system according to claim 16, wherein the one or more computer units are further configured to perform operations including to utilize one or more of a multilayer neural network, a recurrent neural network, a convolutional neural network, or an autoencoder as the artificial intelligence system.

19. The system according to claim 16, wherein the operating data sets (BDS) include vehicle bus data and traffic-specific data representative of traffic volumes or current traffic situations, and the test data sets (TDS) include traffic data, maintenance data, mapping data for the environment in specific GPS coordinates, drive-train related data, and status of vehicle components.

20. The system according to claim 16, wherein the XiL components include hardware vehicle components and a software model of the hardware vehicle components, and the XiL components configured to receive the test data sets (TDS) for performing the XiL simulation, wherein the one or more computer units are further configured to perform operations including to:
determine simulation results of the XiL simulation using the XiL components; and
visualize the simulation results of the XiL components.
